(19) United States
(12) Patent Application Publication
(10) Pub. No.: US 2015/0065077 A1
(43) Pub. Date: Mar. 5, 2015

(54) MOBILE TERMINAL AND METHOD FOR SUPPORTING EMERGENCY CALL

(71) Applicant: LG ELECTRONICS INC., Seoul (KR)

(72) Inventors: Sanggook KIM, San Diego, CA (US); Ki-Dong LEE, San Diego, CA (US)

(73) Assignee: LG ELECTRONICS INC., Seoul (KR)

(21) Appl. No.: 14/288,002

(22) Filed: May 27, 2014

Related U.S. Application Data
(60) Provisional application No. 61/872,590, filed on Aug. 30, 2013.

(51) Int. Cl. H04W 4/22

(52) U.S. Cl. CPC H04W 4/22
USPC 455/404.1

(57) ABSTRACT

The present invention is directed to a method and an apparatus for use in a wireless communication system, in which the method comprises: receiving a broadcast signal including a first country code; obtaining first key input related with requesting an emergency call in a home country, wherein the home country corresponds to a second country code that is registered for the UE; and making the emergency call using a phone number based on the first key input, wherein if the first country code is identical with the second country code, an emergency phone number used in the home country is mapped to the phone number or the first key input is used as the phone number, wherein if the first country code is different from the second country code, an emergency phone number used in a current country corresponding to the first country code is mapped to the phone number.

Pursuant to 35 U.S.C. §119(e), this application claims the benefit of U.S. provisional application 61/872,590, filed on Aug. 30, 2013, which is hereby incorporated by reference as if fully set forth herein.

### TECHNICAL FIELD

The present invention is directed to a method and an apparatus for use in a wireless communication system. Specifically, the present invention is directed to a method and an apparatus for supporting an emergency call.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components.

### DISCLOSURE

### Technical Problem

An object of the present invention is to provide a method and an apparatus of efficiently supporting emergency call, preferably while roaming in foreign country.

It will be appreciated by persons skilled in the art that the objects that can be achieved through the present invention are not limited to what have been particularly described hereinabove and the above and other objects that the present invention can achieve will be more clearly understood from the following detailed description taken in conjunction with the accompanying drawings.

### Technical Solution

As an aspect of the invention, a method of making an emergency call at a mobile terminal in a wireless communication system is provided, in which the method comprises: receiving a broadcast signal including a first country code; obtaining first key input related with requesting an emergency call in a home country, wherein the home country corresponds to a second country code that is registered for the mobile terminal; and making the emergency call using a phone number based on the first key input, wherein if the first country code is identical with the second country code, an emergency phone number used in the home country is mapped to the phone number or the first key input is used as the phone number, wherein if the first country code is different from the second country code, an emergency phone number used in a current country corresponding to the first country code is mapped to the phone number.

Preferably, the broadcast signal may include system information or a beacon signal.

Preferably, the broadcast signal may further include a set of emergency phone numbers used in the current country corresponding to the first country code.

Preferably, if the first country code is different from the second country code, and if plural emergency phone numbers are used in the current country, the method may further comprise: displaying the plural emergency phone numbers used in the current country; obtaining second key input selecting one of the plural emergency phone numbers; and mapping the selected emergency phone number to the phone number.

Preferably, if the first country code is different from the second country code, the method may further comprise: displaying one or more emergency situations associated with the phone number after the emergency call is successfully connected to an emergency center; obtaining third key input selecting one of the two or more emergency situations; and sending a voice signal regarding the selected emergency situation and location information of the UE to the emergency center.

Preferably, the method may further comprise: taking a first voice signal of home country language from a microphone; and transmitting a second voice signal corresponding to the first voice signal to the emergency center, wherein if the first country code is different from the second country code, the second voice signal is generated by translating the first voice signal using the first country code.

Preferably, the method may be further comprising: taking a first text message of home country language corresponding to an emergency situation from a display; and transmitting a second text message corresponding to the first text message to the emergency center, wherein if the first country code is different from the second country code, the second text message is generated by translating the first text message using the first country code.

As another aspect of the invention, a mobile terminal for use in a wireless communication system is provided, in which the mobile terminal comprises: a wireless communication unit; a display; a microphone; and a controller configured to: receive a broadcast signal including a first country code, obtain first key input related with requesting an emergency call in a home country, wherein the home country corresponds to a second country code that is registered for the mobile terminal, and make the emergency call using a phone number based on the first key input, wherein if the first country code is identical with the second country code, an emergency phone number used in the home country is mapped to the phone number or the first key input is used as the phone number, wherein if the first country code is different from the second country code, an emergency phone number used in a current country corresponding to the first country code is mapped to the phone number.

Preferably, the broadcast signal may include system information or a beacon signal.

Preferably, the broadcast signal may further include a set of emergency phone numbers used in the current country corresponding to the first country code.

Preferably, if the first country code is different from the second country code, and if plural emergency phone numbers are used in the current country, the controller may be further configured to: display the plural emergency phone numbers used in the current country, obtain second key input selecting one of the plural emergency phone numbers, and map the selected emergency phone number to the phone number.

Preferably, if the first country code is different from the second country code, the controller may be further configured to: display one or more emergency situations associated with the phone number after the emergency call is successfully connected to an emergency center, obtain third key input selecting one of the two or more emergency situations, and send a voice signal regarding the selected emergency situation and location information of the UE to the emergency center.

Preferably, the controller may be further configured to: take a first voice signal of home country language from a microphone, and transmit a second voice signal corresponding to the first voice signal to the emergency center, wherein if the first country code is different from the second country code, the second voice signal is generated by translating the first voice signal using the first country code.

Preferably, the controller may be further configured to: take a first text message of home country language corresponding to an emergency situation from a display, and transmit a second text message corresponding to the first text message to the emergency center, wherein if the first country code is different from the second country code, the second text message is generated by translating the first text message using the first country code.

### Advantageous Effects

Exemplary embodiments of the present invention have the following effects. In accordance with the embodiments of the present invention, an efficient procedure for supporting emergency call, preferably while roaming in foreign country is provided.

It will be appreciated by persons skilled in the art that the effects that can be achieved through the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention.

FIG. 1A is a block diagram of a mobile terminal in accordance with the present disclosure.

FIGS. 1B and 1C are conceptual views of one example of the mobile terminal, viewed from different directions;

FIGS. 2˜5 show examples of making emergency call according to the present invention.

FIGS. 6A˜6B and 7A˜7C show examples of making emergency calls in accordance with the present invention.

FIG. 8 shows an attach procedure according to the present invention.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Mobile terminals presented herein may be implemented using a variety of different types of terminals. Examples of such terminals include cellular phones, smart phones, user equipment (UE), laptop computers, digital broadcast terminals, personal digital assistants (PDAs), portable multimedia players (PMPs), navigators, portable computers (PCs), slate PCs, tablet PCs, ultra books, wearable devices (e.g., smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

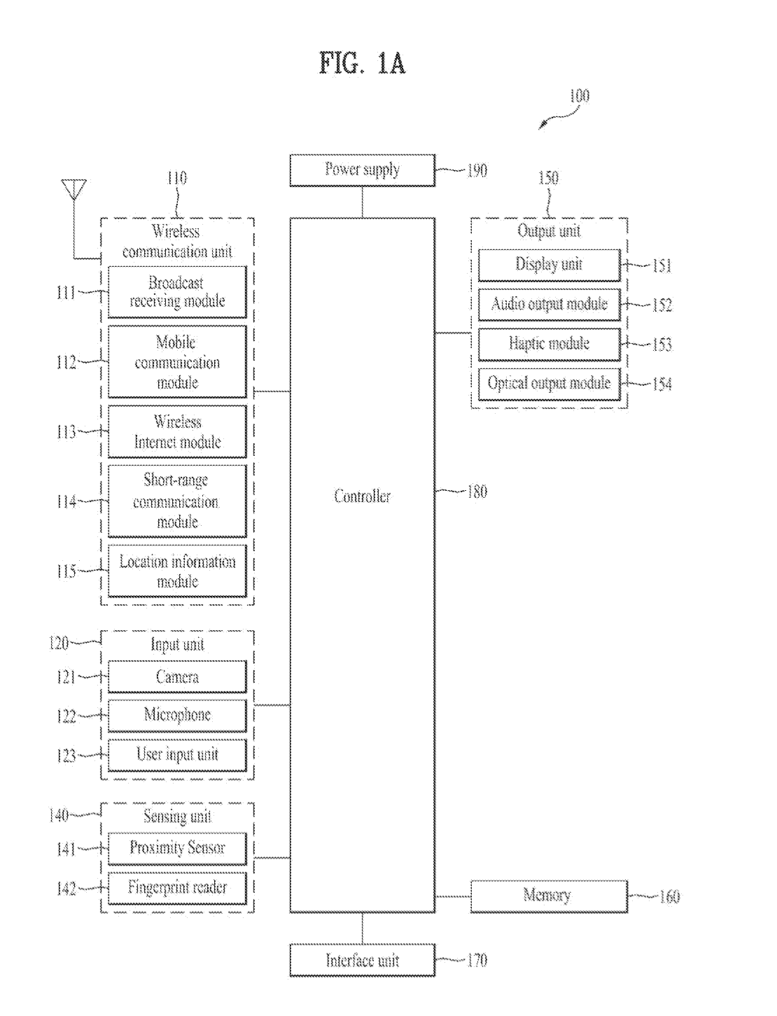

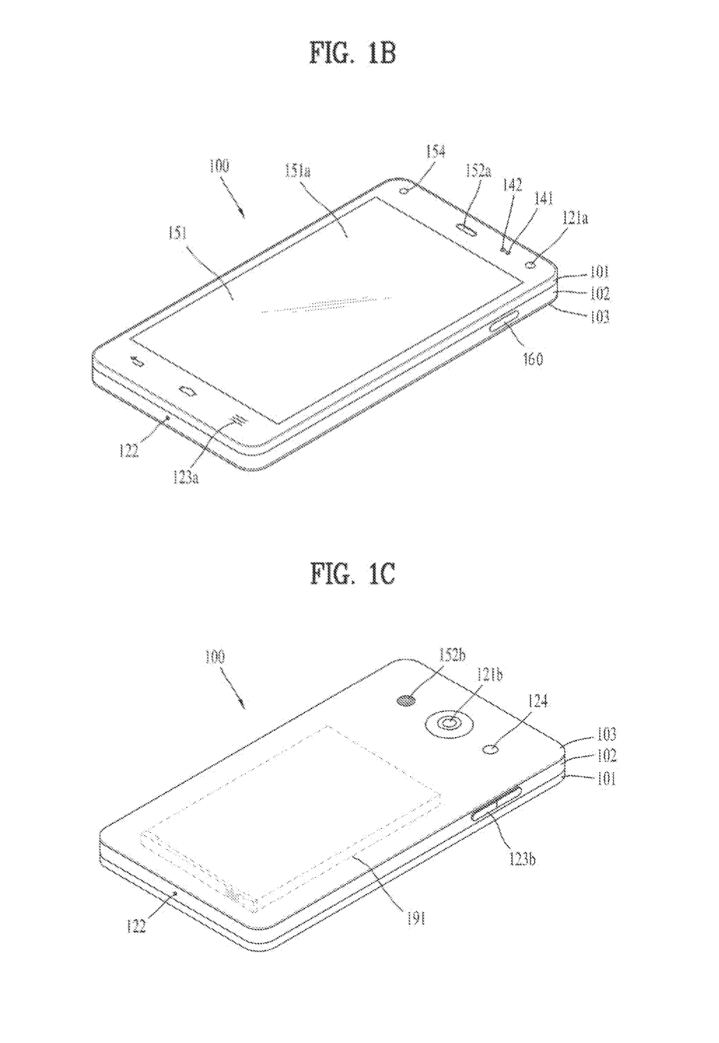

Reference is made to FIGS. 1A-1C, where FIG. 1A is a block diagram of a mobile terminal in accordance with the present disclosure, and FIGS. 1B-1C are conceptual views of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring to FIG. 1A, the mobile terminal 100 has wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122 for inputting an audio signal, and a user input unit 123 (e.g., a touch key, a push key, a mechanical key, a soft key, and the like) for allowing a user to input information. Data (e.g., audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 has a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (e.g., camera 121), a microphone 122, a battery gauge, an environment sensor (e.g., a barometer, a hygrometer, a thermometer, a radiation detection sensor, a thermal sensor, and a gas sensor, among others), and a chemical sensor (e.g., an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (e.g., receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (e.g., bar-type, watch-type, glasses-type, and the like). However, such teachings with regard to a particular type of mobile terminal will generally apply to other types of mobile terminals as well.

The mobile terminal 100 will generally include a case (e.g., frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (e.g., a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (e.g., an earphone, an external speaker, or the like), a port for near field communication (e.g., an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

A communication system which is operable with the variously described mobile terminals will now be described in more detail. Such a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (UMTS) (including, Long Term Evolution (LTE), LTE-A (Long Term Evolution-Advanced)), Global System for Mobile Communications (GSM), and the like.

By way of a non-limiting example only, further description will relate to a CDMA communication system, but such teachings apply equally to other system types including a CDMA wireless communication system as well as OFDM (Orthogonal Frequency Division Multiplexing) wireless communication system. A CDMA wireless communication system generally includes one or more mobile terminals (MT or User Equipment, UE) 100, one or more base stations (BSs, NodeB, or evolved NodeB), one or more base station controllers (BSCs), and a mobile switching center (MSC). The MSC is configured to interface with a conventional Public Switched Telephone Network (PSTN) and the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs can be included in the CDMA wireless communication system.

Each base station may include one or more sectors, each sector having an omni-directional antenna or an antenna pointed in a particular direction radially away from the base station. Alternatively, each sector may include two or more different antennas. Each base station may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In some cases, the term “base station” may be used to refer collectively to a BSC, and one or more base stations. The base stations may also be denoted as “cell sites.” Alternatively, individual sectors of a given base station may be referred to as cell sites.

A broadcasting transmitter (BT) transmits a broadcast signal to the mobile terminals 100 operating within the system. The broadcast receiving module 111 of FIG. 1A is typically configured inside the mobile terminal 100 to receive broadcast signals transmitted by the BT.

Global Positioning System (GPS) satellites for locating the position of the mobile terminal 100, for example, may cooperate with the CDMA wireless communication system. Useful position information may be obtained with greater or fewer satellites than two satellites. It is to be appreciated that other types of position detection technology, (i.e., location technology that may be used in addition to or instead of GPS location technology) may alternatively be implemented. If desired, at least one of the GPS satellites may alternatively or additionally be configured to provide satellite DMB transmissions.

Further preferred embodiments will be described in more detail with reference to additional drawing figures. It is understood by those skilled in the art that the present features can be embodied in several forms without departing from the characteristics thereof.

Nowadays, trips to foreign countries have become as common as trips to other parts of the same countries due to globalization. Thus emergency situations can be happened in any countries due to the lack of security, accidents, etc. However problems in dialing to emergency authorities may exist because many countries employ different numbers for emergency situations. In addition, even different numbers are supported in a country depending on what emergency authority is being involved, e.g. a police, a fire department, or a medical center. That is, the type of and the number of emergency call (or phone) numbers are different depending on country: e.g., USA (“911”), Mexico (“066”), Maldives (“102”), UK (“999” or “112”), South Korea (“112”, “119”, and many more), etc.

Thus there can be a situation in which a roaming user originally subscribed to an Operator, in which country (e.g. origin: USA) there is only a single emergency call number, moves into another country (e.g., destination: South Korea) in which there are multiple emergency call numbers depending on the type of situations: in USA, 911 is for every emergency situation; however, in South Korea, 119 for medical staff, 112 for police, etc. In such a situation, the roaming user does not know which number the user should use to make an emergency call: for example, the USA user travelling to South Korea has a hazardous choking situation, attempting to make a call via using “911” (the emergency call number used in the USA). In USA, this call initiation request will be connected to the Public Safety Answering Point (PSAP), but in South Korea, it may not work. Also, if the USA user knows an emergency call number in South Korea, it can be one of medical, police, etc. It is thus highly probable that this emergency call will be delivered to inappropriate emergency authority, which is a critical problem under life-threatening emergency situation.

In order to address the aforementioned problems, methods to support emergency call while roaming in foreign countries will be proposed as follows.

Method 1: Without Using Emergency Call Number(s) in the Country (Hereinafter, Referred to as Home Country) where a Phone is Registered.

To support emergency call while roaming in a foreign country, emergency call information can be provided to a cellular phone as shown in Cases 1-2 below. The emergency call information includes a list of emergency call numbers. If necessary (e.g., plural emergency calls in a country), the emergency call information may further include a list of associated information for respective emergency call number (e.g., departments/authorities/situations for emergency call numbers). For example, the emergency call information may include [“119” for medical staff, “112” for police] for South Korea.
Case 1: Provided by a handset vendor. Emergency call information for all or some countries in the world may be stored into a phone before delivering.
Case 2: Provided by a network operator. The network operator may provide emergency call information on the country it belongs to using broadcast information (e.g., a beacon signal, system information, etc.). The network operator may provide emergency call information in a geographical scale (e.g., emergency call information for itself and/or neighboring countries, emergency call information for all countries).

Based on the emergency call information, the roaming user is able to know which number the user should use to make an emergency call: for example, if the USA user travelling to South Korea has a hazardous choking situation, the roaming user may know that “119” is an emergency call number for medical staff in South Korea, and then make an emergency call via using “119”, not “911”.

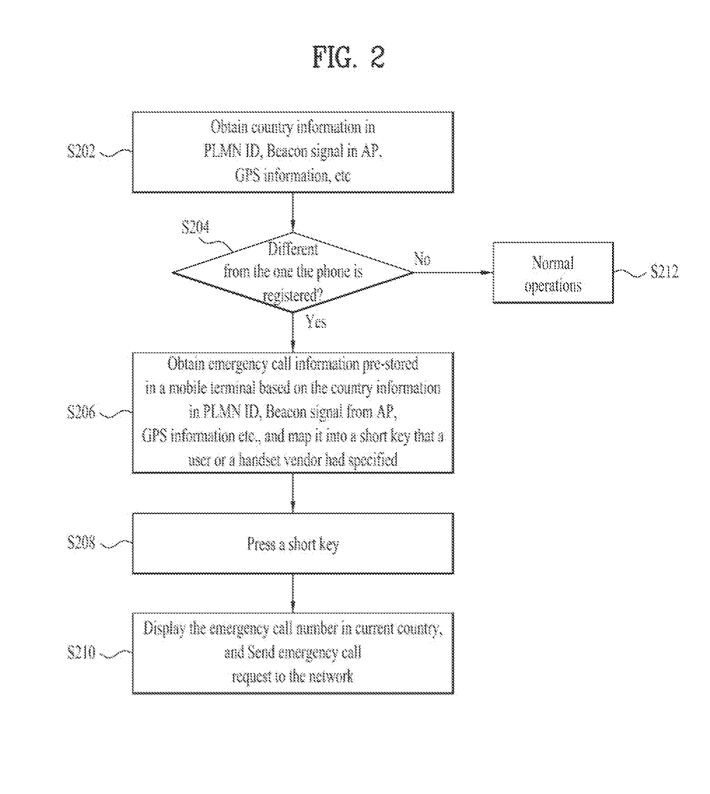

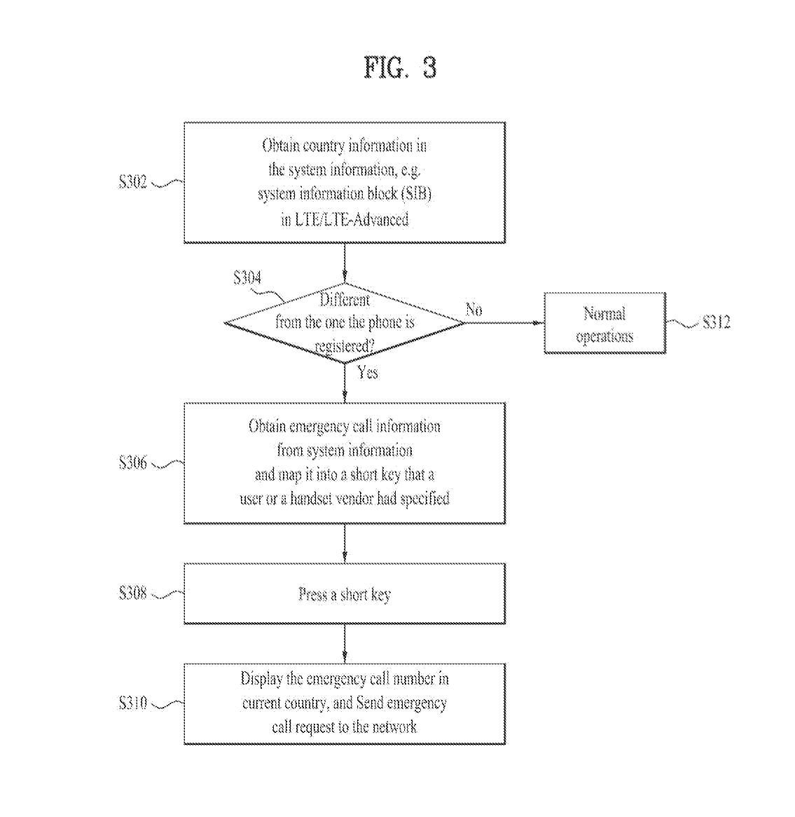

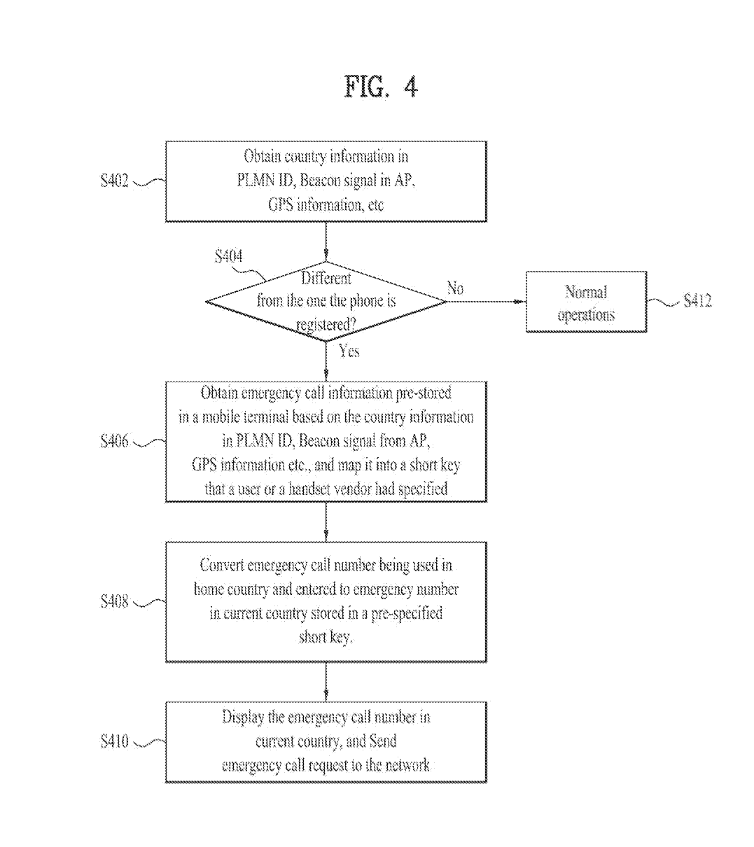

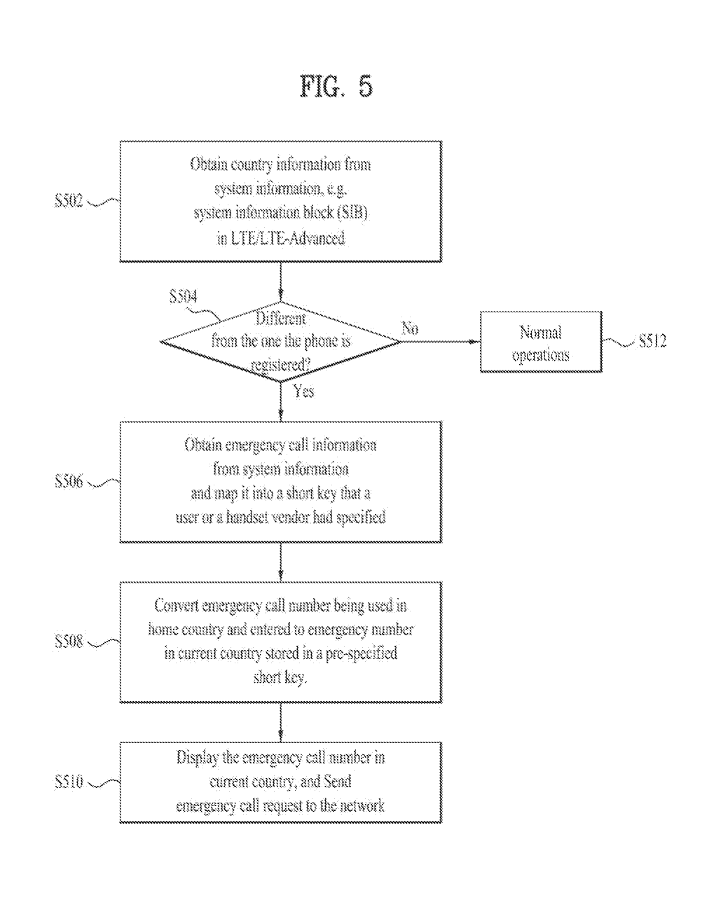

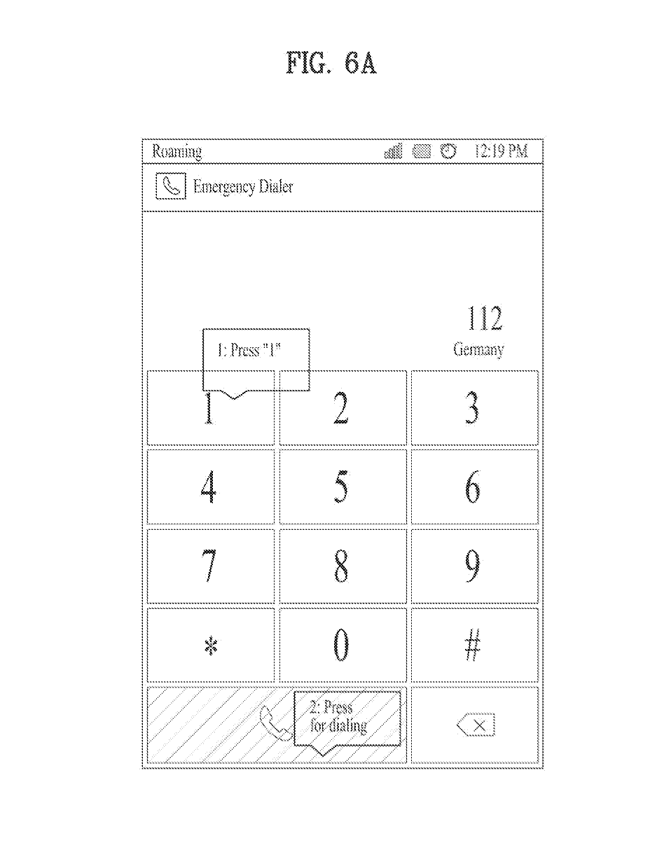

FIGS. 2˜3 show examples of making emergency call according to Method 1.

Referring to FIGS. 2˜3, a mobile terminal may receive Public Land Mobile Network (PLMN) ID, a broadcast signal such as beacon signal in Access Point (AP), Global Positioning System (GPS) information, etc. and obtain country information from PLMN ID, Beacon signal in AP, GPS information, etc. (S202). Alternatively, a mobile terminal may receive broadcast information (e.g., system information) from a network, and obtain country information from system information (S302). The system information may be transmitted as a System Information Block (SIB) in LTE/LTE-Advanced). The country information may include a country code, preferably a Mobile Country Code, MCC, for a location where the mobile terminal is located. For example, MCCs for countries are as follows: 234 (UK), 310 (USA), 450 (South Korea), etc.

Then, the mobile terminal may check whether the country information (S202 and S302) of a current country correspond to a home country or not (S204 and S304). Here, the home country represents a country to which the mobile terminal is registered, and a foreign country represents a country other than the home country. Specifically, the mobile terminal may check whether a country code (S202 and S302) of the current country is different from a country code of the home country or not. If the country information (S202 and S302) of the current country correspond to the home country (i.e., not roaming situation), the mobile terminal perform a normal procedure to make an emergency call (S212 and S312). For example, when the mobile terminal may make an emergency call using a phone number corresponding to a key input (or based on a key input), and an emergency phone number used in the home country is mapped to the phone number (in a case that the key input is a short key) or the first key input is used as the phone number (in a case that the key input is not a short key).

If the country information (S202 and S302) of the current country does not correspond to the home country (i.e., roaming situation), the mobile terminal may perform a following procedure to support an emergency call while roaming in a foreign country. Specifically, the mobile terminal may obtain emergency call information pre-stored in the mobile terminal based on the country information (e.g., MCC) in PLMN ID, beacon signal from AP, GPS information etc., and map it into a short key that a user or a handset vendor had specified (S206). Here the emergency call information may be pre-stored in a way of Case 1 of Method 1, i.e., emergency call information for all or some countries in the world may be stored into the phone by handset vendor before delivering. Here the short key may correspond to a single key input (e.g., “send” or “call” button), a combination of one or more keys and one or more actions (e.g., long press of “#”) or a combination of plural key inputs (e.g., “911”+“send” or “911”+“call”). Alternatively, the mobile terminal may obtain emergency call information from broadcast information (e.g., system information) and map it into a short key that a user or a handset vendor had specified (S306). The emergency call information in the system information may include a list of emergency call numbers. If necessary (e.g., plural emergency call in a country), the emergency call information may further include a list of associated information for respective emergency call number (e.g., department/authority for a corresponding emergency call number). For example, the emergency call information may include [119 for medical staff, 112 for police] for South Korea.

And, if a user presses the short key in the mobile terminal (S208 and S308), the mobile may display a corresponding emergency call number in a current country (i.e., foreign country), and send an emergency call request to a network (S210 and S310). If there are plural emergency call numbers in the current country, the mobile terminal may display a list of emergency call numbers and associated departments/authorities/situations and a user may select one of them to make an emergency call in the foreign country. For example, if plural emergency call numbers are used in the current country, the mobile terminal may perform following operations: displaying the plural emergency call numbers used in the current country (along with associated departments/authorities); obtaining another key input selecting one of the plural emergency call numbers; mapping the selected emergency call number to a phone number; and making an emergency call using the phone number. If both the home country and the current country support plural emergency call numbers, the mobile terminal displays one emergency call number of the plural emergency call number used in the foreign country which corresponds to the entered emergency call number based on the department/authority for the entered emergency call number.

Even though not shown in figures, in order to support emergency call in foreign country, following operations may be further performed.
Option 1-A: Mobile terminal may display one or more associated emergency situations (e.g., in USA, (i) traffic accident, (ii) robbery, (iii) medical emergency, (iv) fire, . . . ) (i.e., emergency situation(s) related with a corresponding emergency call number after the emergency call is successfully connected to an emergency center, obtain another key input selecting one of the two or more emergency situations, and send a voice signal (or a text message) regarding the selected emergency situation and/or location information of the mobile terminal to the emergency center. In this case, a set of [emergency, corresponding voice signal (or corresponding text message)]s may be stored by a handset vendor and/or recorded/defined by a user.
Option 1-B: Mobile terminal may take a first voice signal of home country language from a microphone after the emergency call is successfully connected to an emergency center, and transmit a second voice signal corresponding to the first voice signal to the emergency center, wherein if MCC of a current country is different from MCC of a home country, the second voice signal is generated by translating the first voice signal using the MCC of the current country. For example, the mobile terminal first assumes that a voice signal from the microphone is made in a language of home country. And, if the MCC of the current country is different form the MCC of the home country, for translating the voice signal in the language of home country, the mobile terminal may transmit a message for requesting translation of a text corresponding to the voice signal from a language of the home country to a language of the current country to a web providing translation service like the google translate (e.g., http://translate.google.com), receive a message including a translated text, generate a voice signal corresponding to the translated text by using a Text-to-Speech (TTS) function, and transmit the voice signal corresponding to the translated text to the emergency center.

The Option 1-B shows the case of a voice signal in the language of home country to a voice signal in the language of a foreign country (i.e., current country). However following cases are also possible with slight modifications of the Option 1-B: (i) a voice signal in the language of home country to a text message in the language of a foreign country (i.e., current country), (ii) a test message in the language of home country to a voice signal in the language of a foreign country (i.e., current country), and (iii) a test message in the language of home country to a text message in the language of a foreign country (i.e., current country). For example, in case of (iii), the mobile terminal may take a first text message of home country language corresponding to an emergency situation from a display, and transmit a second text message corresponding to the first text message to the emergency center, wherein if MCC of the current country is different from MCC of the home country, the second text message is generated by translating the first text message using the MCC of the current country.

Method 2: Using Emergency Call Number(s) in the Country (i.e., Home Country) where a Phone is Registered.

Emergency call information can be provided to a cellular phone in two ways previously described (see, Cases 1-2 in Method 1). In this method, user may simply input emergency number used in home country where the phone is registered and then press a pre-specified key (e.g., short key) or “send” button, and then emergency number is converted into the one in current country and delivered to the network. When more than one emergency number is supported, a list of emergency numbers with associated information may be shown when a pre-specified key or “send” button is pressed. User may select one and then the selected number is dialed through the network.

FIGS. 4˜5 show examples of making emergency call according to Method 2.

Referring to FIGS. 4˜5, a mobile terminal may receive Public Land Mobile Network (PLMN) ID, Beacon signal in Access Point (AP), Global Positioning System (GPS) information, etc. and obtain country information from PLMN ID, Beacon signal in AP, GPS information, etc. (S402). Alternative, a mobile terminal may receive broadcast information (e.g., system information) from a network, and obtain country information from system information (S502). The system information may be transmitted as a part of system information block (SIB) in LTE/LTE-Advanced. The country information may include a country code, preferably a mobile country code, MCC, for a location where the mobile terminal is located. For example, MCCs for countries are as follows: 234 (UK), 310 (USA), 450 (South Korea), etc.

Then, the mobile terminal may check whether the country information (S402 and S502) of a current country correspond to a home country or not (S204 and S304). Here, the home country represents a country to which the mobile terminal is registered, and a foreign country represents a country other than the home country. Specifically, the mobile terminal may check whether a country code (S402 and S502) of the current country is different from a country code of the home country or not. If the country information (S402 and S502) of the current country correspond to the home country (i.e., not roaming situation), the mobile terminal perform a normal procedure to make an emergency call (S412 and S512). For example, when the mobile terminal may make an emergency call using a phone number corresponding to a key input (or based on a key input), and an emergency phone number used in the home country is mapped to the phone number (in a case that the key input is a short key) or the first key input is used as the phone number (in a case that the key input is not a short key).

If the country information (S402 and S502) of the current country does not correspond to the home country (i.e., roaming situation), the mobile terminal may obtain emergency call information pre-stored in the mobile terminal based on the country information (e.g., MCC) in PLMN ID, beacon signal from AP, GPS information etc., and map it into a short key that a user or a handset vendor had specified (S406). Here the emergency call information may be pre-stored in a way of Case 1 of Method 1, i.e., emergency call information for all or some countries in the world may be stored into the phone by handset vendor before delivering. Here the short key may correspond to a single key input (e.g., “send” or “call” button), a combination of one or more keys and one or more actions (e.g., long press of “#”) or a combination of plural key inputs (e.g., “911”+“send” or “911”+“call”). Alternatively, the mobile terminal may obtain emergency call information from broadcast information (e.g., system information) and map it into a short key that a user or a handset vendor had specified (S506). The emergency call information in the system information may include a list of Emergency Call numbers. If necessary (e.g., plural emergency call in a country), the emergency call information may further include a list of associated information for respective emergency call number (e.g., department/authority for a corresponding emergency call number). For example, the emergency call information may include [119 for medical staff, 112 for police] for South Korea.

And, if a user enters an emergency number in the home country and the short key, the mobile terminal may convert the entered emergency number in the home country to an emergency number in the current country which is mapped to/stored in the short key (S408 and S508). Then, the mobile may display a corresponding emergency call number in a current country (i.e., foreign country), and send an emergency call request to a network (S410 and S510). If there are plural emergency call numbers in the current country, the mobile terminal may display a list of emergency call numbers and associated departments/authorities/situations and a user may select one of them to make an emergency call in the foreign country. For example, if plural emergency call numbers are used in the current country, the mobile terminal may perform following operations: displaying the plural emergency call numbers used in the current country (along with associated departments/authorities); obtaining another key input selecting one of the plural emergency call numbers; mapping the selected emergency call number to a phone number; and making an emergency call using the phone number. If both the home country and the current country support plural emergency call numbers, the mobile terminal displays one emergency call number of the plural emergency call number used in the foreign country which corresponds to the entered emergency call number based on the department/authority for the entered emergency call number.

Even though not shown in figures, in order to support emergency call in foreign country, following operations may be further performed.
Option 2-A: Mobile terminal may display one or more associated emergency situations (e.g., in USA, (i) traffic accident, (ii) robbery, (iii) medical emergency, (iv) fire, . . . ) (i.e., emergency situation(s) related with a corresponding emergency call number) after the emergency call is successfully connected to an emergency center, obtain another key input selecting one of the two or more emergency situations, and send a voice signal (or a text message) regarding the selected emergency situation and location information of the mobile terminal to the emergency center. In this case, a set of [emergency, corresponding voice signal (or corresponding text message)]s may be stored by a handset vendor and/or recorded/defined by a user.
Option 2-B: Mobile terminal may take a first voice signal of home country language from a microphone after the emergency call is successfully connected to an emergency center, and transmit a second voice signal corresponding to the first voice signal to the emergency center, wherein if MCC of a current country is different from MCC of a home country, the second voice signal is generated by translating the first voice signal using the MCC of the current country. For example, the mobile terminal first assumes that a voice signal from the microphone is made in a language of home country. And, if the MCC of the current country is different form the MCC of the home country, for translating the voice signal in the language of home country, the mobile terminal may transmit a message for requesting translation of a text corresponding to the voice signal from a language of the home country to a language of the current country to a web providing translation service like the google translate (e.g., http://translate.google.com), receive a message including a translated text, generate a voice signal corresponding to the translated text by using a Text-to-Speech (TTS) function, and transmit the voice signal corresponding to the translated text to the emergency center.

The Option 2-B shows the case of a voice signal in the language of home country to a voice signal in the language of a foreign country (i.e., current country). However following cases are also possible with slight modifications of the Option 2-B: (i) a voice signal in the language of home country to a text message in the language of a foreign country (i.e., current country), (ii) a test message in the language of home country to a voice signal in the language of a foreign country (i.e., current country), and (iii) a test message in the language of home country to a text message in the language of a foreign country (i.e., current country). For example, in case of (iii), the mobile terminal may take a first text message of home country language corresponding to an emergency situation from a display, and transmit a second text message corresponding to the first text message to the emergency center, wherein if MCC of the current country is different from MCC of the home country, the second text message is generated by translating the first text message using the MCC of the current country.

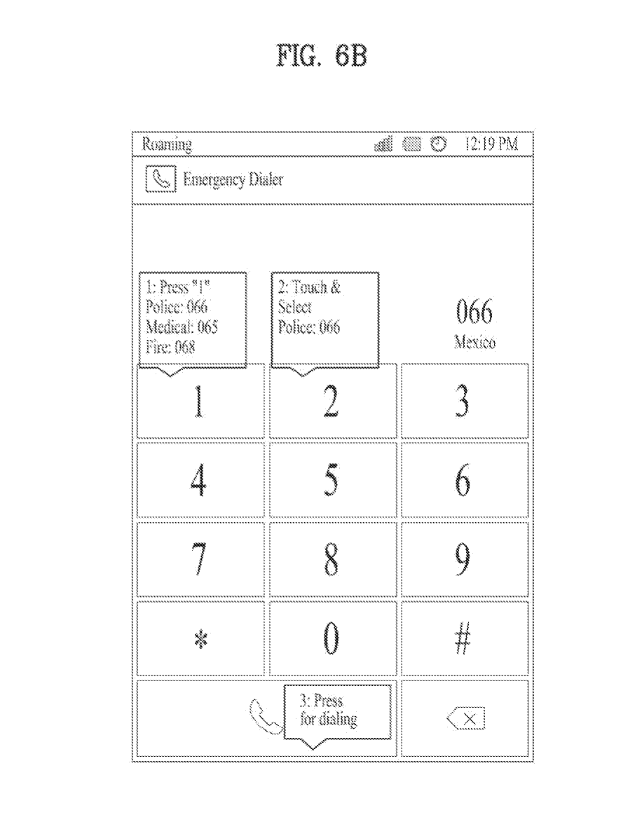

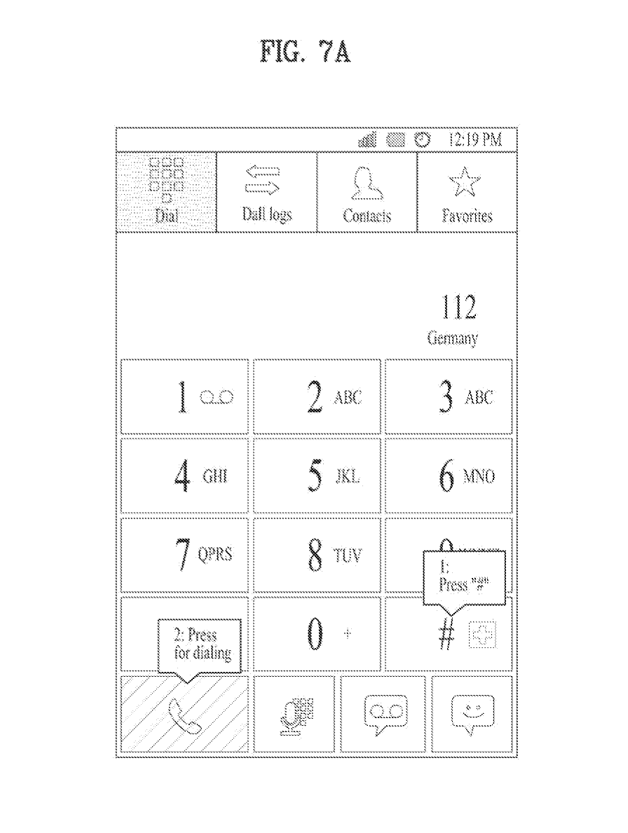

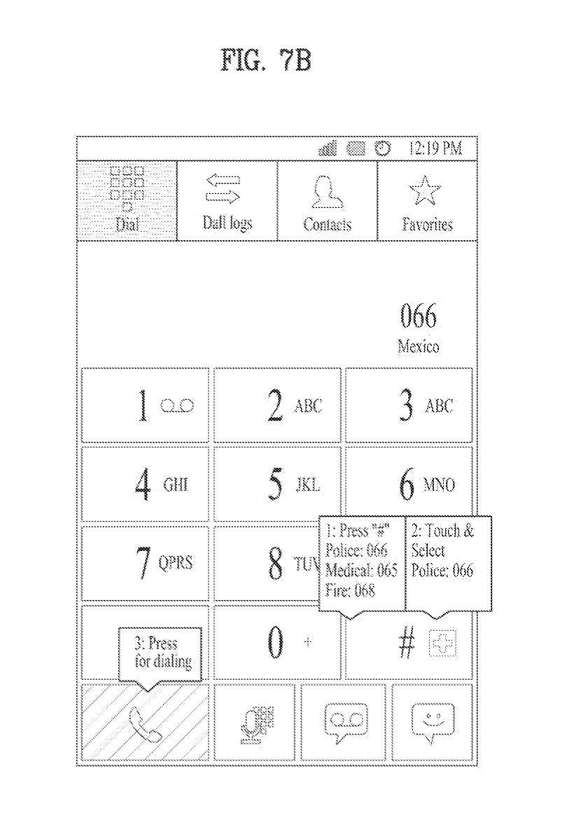

FIGS. 6A˜7C show examples of making emergency calls in accordance with the present invention. FIGS. 6A˜6B show cases of emergency dialer, and FIGS. 7A˜7C show cases of normal dialer. The emergency dialer represents a dialer which has pre-determined (or handset vendor-defined) short key(s) for emergency call (e.g., long press “1” button for emergency call). When the emergency dialer is enabled, user-defined short keys are ignored. The normal dialer represents a dialer used for a normal use, which has user-defined short keys. Referring to FIGS. 6A˜7C, below implementations for user interface can be considered to make emergency calls.

Implementation 1: Roaming into Germany (Method 1) (FIG. 6A)

Germany provides one emergency call number, i.e., “112”. For Germany, emergency call information including “112” may be pre-stored by a handset vendor or signaled by using broadcast information (e.g., beacon, system information, etc.). When a mobile terminal may obtain a MCC corresponding to Germany, the mobile terminal may map the emergency number “112” into a short key (e.g., “1”). The MCC may be obtained from PLMN ID, beacon signal from AP, GPS information, or system information. In this situation, when a user presses “1” button more than a pre-determined time, the mobile terminal may display the emergency number, i.e., “112”, linked to the short key. And, if the user presses “send” or “call” button, the mobile terminal may send an emergency call request to a network by using the emergency call number in Germany.

Implementation 2: Roaming into Mexico (Method 1) (FIG. 6B)

Mexico provides a plurality of emergency calls, i.e., “066” (police), “065” (medical), “068” (fire), etc. For Mexico, emergency call information including a list of [emergency call number, department/authority/situation]s may be pre-stored by a handset vendor or signaled by using broadcast information (e.g., beacon, system information, etc.). When a mobile terminal may obtain a MCC corresponding to Mexico, the mobile terminal may map the list of [emergency call number, department/authority/situation]s into a short key (e.g., “1”). In this situation, when a user presses “1” button more than a pre-determined time, the mobile terminal may first display the list of [emergency call number, department/authority/situation]s. Then, when the user selects one (e.g., “066” for police) of emergency call numbers and presses “send” or “call” button, the mobile terminal send an emergency call request to a network by using the selected emergency call number.

Implementation 3: Roaming into Germany (Method 1) (FIG. 7A)

Germany provides one emergency call number, i.e., “112”. For Germany, emergency call information including “112” may be pre-stored by a handset vendor or signaled by using broadcast information (e.g., beacon, system information, etc.). When a mobile terminal may obtain a Mobile Country Code (MCC) corresponding to Germany, the mobile terminal may map the emergency number 112 into a short key (e.g., “#”). In this implementation, “#” is designated as emergency key by placing a symbol (e.g., a red cross). The MCC may be obtained from PLMN ID, beacon signal from AP, GPS information, or system information. In this situation, when a user presses “#” button more than a pre-determined time, the mobile terminal may display the emergency number, i.e., “112”, linked to the short key. And, if the user presses “send” or “call” button, the mobile terminal may send an emergency call request to a network by using the emergency call number in Germany.

Implementation 4: Roaming into Mexico (Method 1) (FIG. 7B)

Mexico provides a plurality of emergency calls, i.e., “066” (police), “065” (medical), “068” (fire), etc. For Mexico, emergency call information including a list of [emergency call number, department/authority/situation]s may be pre-stored by a handset vendor or signaled by using broadcast information (e.g., beacon, system information, etc.). When a mobile terminal may obtain a MCC corresponding to Mexico, the mobile terminal may map the list of [emergency call number, department/authority/situation]s into a short key (e.g., “#”). In this implementation, “#” is designated as emergency key by placing a symbol (e.g., a red cross). In this situation, when a user presses “#” button more than a pre-determined time, the mobile terminal may first display the list of [emergency call number, department/authority/situation]s. Then, when the user selects one (e.g., “066” for police) of emergency call numbers and presses “send” or “call” button, the mobile terminal send an emergency call request to a network by using the selected emergency call number.

Implementation 5: Roaming into USA (Method 2) (FIG. 7C)

USA provides one emergency call number, i.e., “911”. For USA, emergency call information including “911” may be pre-stored by a handset vendor or signaled by using broadcast information (e.g., beacon, system information, etc.). When a mobile terminal may obtain a MCC corresponding to USA, the mobile terminal may map the emergency number “911” into a short key (e.g., “#”). For explanation, it is assumed that “112” is an emergency number used in home country (i.e., Germany). In this implementation, “#” is designated as emergency key by placing a symbol (e.g., a red cross). In this implementation, when a user inputs the emergency call number of the home country (i.e., Germany) and the short key, the mobile terminal may convert the emergency call number of the home country (i.e., Germany) to the emergency call number of the current country (i.e., USA) in consideration of the MCC of the current country. For example, when a user simply presses the emergency number of the home country, i.e., “112” and then “#” button, the mobile terminal may display the emergency number in USA. And, if the user presses “send” or “call” button, the mobile terminal may send an emergency call request to a network by using the emergency number in USA.

Next, a method of signaling emergency call information will be explained in more detail. Below method may be limited to a case where a mobile terminal has no Universal Integrated Circuit Card (UICC) (Universal Subscriber Identity Module).

When a UE enters a foreign coverage area served by E-UTRAN (and/or UTRAN, other RAT, such as CDMA, cdma2000, etc.), actions of a network and a mobile terminal can be performed as follows:

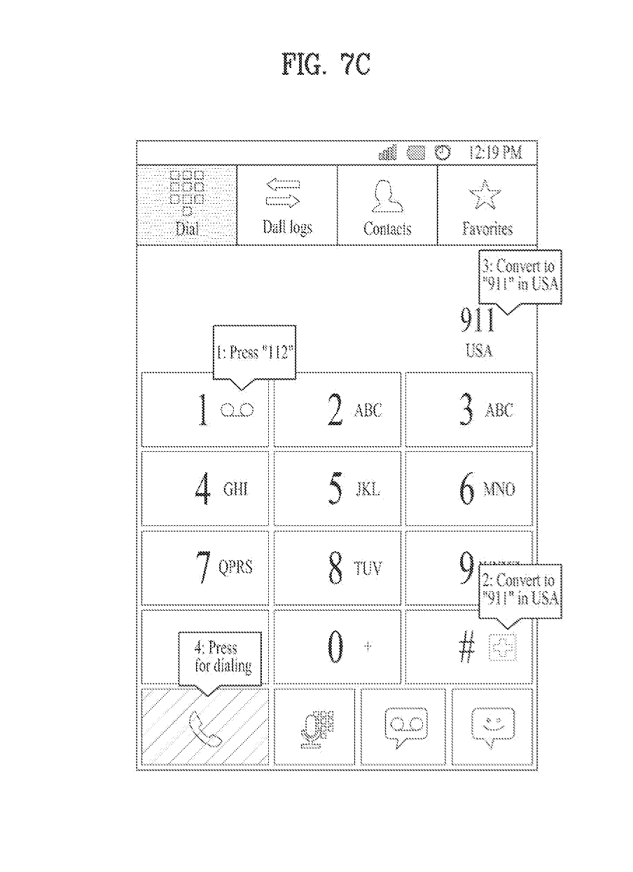

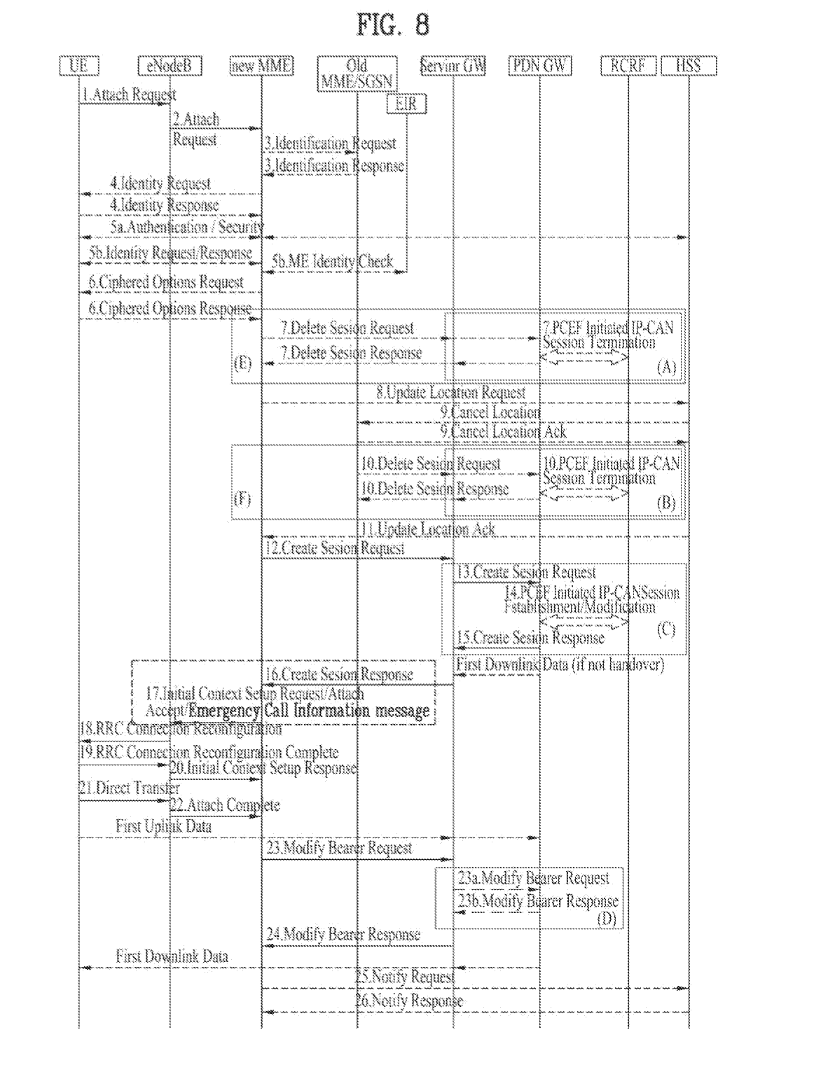

Network Action: 3GPP Case
Step 1: Mobility Management Entity (MME) may inform eNB(s) of the emergency call information. The emergency call information message may include: the type of emergency call numbers used in a roaming country (e.g., in South Korea, “112” for police, “119” for fire/medical, “nnn1” for situation sss1, “nnn2” for situation sss2, etc.). An eNB or MME doesn't have to know of the existence of a mobile terminal (or a mobile terminal without subscription information/identity) in the coverage area of the eNB. That is, the emergency call information may be transmitted from the MME to the eNB, irrespective of the existence of the mobile terminal. Alternatively, the emergency call information may be transmitted as a part of an attach procedure. FIG. 8 shows an attach procedure according to the present invention. Referring to FIG. 8, the emergency call information may be signaled via step 17.
Step 2: The eNB may make an emergency call information message based on the emergency call information to broadcast the emergency call information through a new System Information Block (SIB) or an existing SIB using some additional field to carry this information. In cdma2000 case, the emergency call information can be delivered using a synchronization channel message and/or a paging message

Mobile Terminal Action:
Step 3: Mobile terminal can remove the previous emergency call information of previously visited roaming country, if any.
Step 4: Mobile terminal may obtain emergency call information of a current country from the received emergency call information message (e.g., through some appropriate interpretation/translation, if necessary), and store it. For example, the mobile terminal may store emergency call number(s) of the current country.
Step 5: Mobile terminal may use the stored emergency call numbers as depicted in Implementations 1, 2, 3, 4, and/or 5 (see, FIGS. 6A-6B and 7A-7C).

Various embodiments may be implemented using a machine-readable medium having instructions stored thereon for execution by a processor to perform various methods presented herein. Examples of possible machine-readable mediums include HDD(Hard Disk Drive), SSD(Solid State Disk), SDD(Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (e.g., a transmission over the Internet). The processor may include the controller 180 of the mobile terminal.

The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

### INDUSTRIAL APPLICABILITY

The present invention can be applied to a method and an apparatuses for supporting emergency call while roaming in foreign country.

1. A method of making an emergency call at a mobile terminal in a wireless communication system, the method comprising:
receiving a broadcast signal including a first country code;
obtaining first key input related with requesting an emergency call in a home country, wherein the home country corresponds to a second country code that is registered for the mobile terminal; and
making the emergency call using a phone number based on the first key input,
wherein if the first country code is identical with the second country code, an emergency phone number used in the home country is mapped to the phone number or the first key input is used as the phone number,
wherein if the first country code is different from the second country code, an emergency phone number used in a current country corresponding to the first country code is mapped to the phone number.

2. The method of claim 1, wherein the broadcast signal includes system information or a beacon signal.

3. The method of claim 1, wherein the broadcast signal further includes a set of emergency phone numbers used in the current country corresponding to the first country code.

4. The method of claim 1, wherein if the first country code is different from the second country code, and if plural emergency phone numbers are used in the current country, further comprising:
displaying the plural emergency phone numbers used in the current country;
obtaining second key input selecting one of the plural emergency phone numbers; and
mapping the selected emergency phone number to the phone number.

5. The method of claim 1, wherein if the first country code is different from the second country code, further comprising:
displaying one or more emergency situations associated with the phone number after the emergency call is successfully connected to an emergency center;
obtaining third key input selecting one of the two or more emergency situations; and
sending a voice signal regarding the selected emergency situation and location information of the UE to the emergency center.

6. The method of claim 1, further comprising:
taking a first voice signal of home country language from a microphone; and
transmitting a second voice signal corresponding to the first voice signal to the emergency center,
wherein if the first country code is different from the second country code, the second voice signal is generated by translating the first voice signal using the first country code.

7. The method of claim 1, further comprising:
taking a first text message of home country language corresponding to an emergency situation from a display; and
transmitting a second text message corresponding to the first text message to the emergency center,
wherein if the first country code is different from the second country code, the second text message is generated by translating the first text message using the first country code.

8. A mobile terminal for use in a wireless communication system, the mobile terminal comprising:
a wireless communication unit;
a display;
a microphone; and
a controller configured to:
receive a broadcast signal including a first country code,
obtain first key input related with requesting an emergency call in a home country, wherein the home country corresponds to a second country code that is registered for the mobile terminal, and
make the emergency call using a phone number based on the first key input,
wherein if the first country code is identical with the second country code, an emergency phone number used in the home country is mapped to the phone number or the first key input is used as the phone number,
wherein if the first country code is different from the second country code, an emergency phone number used in a current country corresponding to the first country code is mapped to the phone number.

9. The mobile terminal of claim 8, wherein the broadcast signal includes system information or a beacon signal.

10. The mobile terminal of claim 8, wherein the broadcast signal further includes a set of emergency phone numbers used in the current country corresponding to the first country code.

11. The mobile terminal of claim 8, wherein if the first country code is different from the second country code, and if plural emergency phone numbers are used in the current country, the controller is further configured to:
display the plural emergency phone numbers used in the current country,
obtain second key input selecting one of the plural emergency phone numbers, and
map the selected emergency phone number to the phone number.

12. The mobile terminal of claim 8, wherein if the first country code is different from the second country code, the controller is further configured to:
display one or more emergency situations associated with the phone number after the emergency call is successfully connected to an emergency center,
obtain third key input selecting one of the two or more emergency situations, and
send a voice signal regarding the selected emergency situation and location information of the UE to the emergency center.

13. The mobile terminal of claim 8, wherein the controller is further configured to:
take a first voice signal of home country language from a microphone, and
transmit a second voice signal corresponding to the first voice signal to the emergency center,
wherein if the first country code is different from the second country code, the second voice signal is generated by translating the first voice signal using the first country code.

14. The mobile terminal of claim 8, wherein the controller is further configured to:
take a first text message of home country language corresponding to an emergency situation from a display, and
transmit a second text message corresponding to the first text message to the emergency center,
wherein if the first country code is different from the second country code, the second text message is generated by translating the first text message using the first country code.
